(19) United States
(12) Patent Application Publication
(10) Pub. No.: US 2025/0253573 A1
(43) Pub. Date: Aug. 7, 2025

(54) CONNECTION STRUCTURE AND ASSEMBLY

(71) Applicant: Yazaki Corporation, Tokyo (JP)

(72) Inventors: Ryoichi MURATA, Makinohara-shi (JP); Toshiharu TAKAHASHI, Makinohara-shi (JP); Yukihiro KAWAMURA, Makinohara-shi (JP)

(73) Assignee: Yazaki Corporation, Tokyo (JP)

(21) Appl. No.: 19/023,643

(22) Filed: Jan. 16, 2025

(30) Foreign Application Priority Data
Feb. 5, 2024 (JP) 2024-015607

(51) Int. Cl. H01R 13/24; H01R 25/16

(52) U.S. Cl. CPC H01R 13/2428; H01R 13/2421; H01R 25/162

(57) ABSTRACT

A connection structure is a connection structure that electrically connects a device and a battery pack. The connection structure includes a first conductor, a second conductor, and an elastic conductor. The first conductor is connected to one of the device and the battery pack. The second conductor is connected to the other of the device and the battery pack. The second conductor overlaps at least a part of the first conductor when viewed in a first direction from the device toward the battery pack. The elastic conductor is arranged between the first conductor and the second conductor in the first direction. The elastic conductor electrically connects the first conductor and the second conductor while being compressed between the first conductor and the second conductor when the device and the battery pack are fixed.

### BACKGROUND OF THE INVENTION

### Field of the Invention

Embodiments of the present invention relate to a connection structure and an assembly.

The present application claims priority to Japanese Patent Application No. 2024-015607 filed in Japan on Feb. 5, 2024, the contents of which are incorporated herein by reference.

### Description of Related Art

A structure in which a battery pack and a device are connected is known. For example, Japanese Unexamined Patent Application, First Publication No. 2018-144524 discloses a structure in which a battery module is connected to a fuse contactor unit of an electric vehicle.

### SUMMARY OF THE INVENTION

In the assembly disclosed in Japanese Unexamined Patent Application, First Publication No. 2018-144524, a power supply-side male terminal provided in a battery module is attached to and detached from each of a plurality of power reception-side female terminals connected to a fuse contactor unit. However, in such a connection structure including terminals, it may be difficult to secure the contact pressure of a conductor.

An object of an embodiment of the present invention is to provide a connection structure and an assembly that easily secure the contact pressure of a conductor.

A connection structure according to an embodiment of the present invention is a connection structure for electrically connecting a device and a battery pack. The connection structure includes a first conductor, a second conductor, and an elastic conductor. The first conductor is connected to one of the device and the battery pack. The second conductor is connected to the other of the device and the battery pack. The second conductor overlaps at least a part of the first conductor when viewed in a first direction from the device toward the battery pack. The elastic conductor is arranged between the first conductor and the second conductor in the first direction. The elastic conductor electrically connects the first conductor and the second conductor while being compressed between the first conductor and the second conductor when the device and the battery pack are fixed.

An assembly according to an embodiment of the present invention includes a device, a battery pack, and a connection structure. The connection structure electrically connects the device and the battery pack. The connection structure includes a first conductor, a second conductor, and an elastic conductor. The first conductor is connected to one of the device and the battery pack. The second conductor is connected to the other of the device and the battery pack. The second conductor overlaps at least a part of the first conductor when viewed in a first direction from the device toward the battery pack. The elastic conductor is arranged between the first conductor and the second conductor in the first direction. The elastic conductor electrically connects the first conductor and the second conductor while being compressed between the first conductor and the second conductor when the device and the battery pack are fixed.

According to an embodiment of the present invention, it is easy to secure the contact pressure of a conductor.

### BRIEF DESCRIPTION OF THE DRAWINGS

FIG. 1 shows a front view illustrating an assembly of a first embodiment.

FIG. 2 shows cross-sectional views taken along line F2-F2 of the assembly illustrated in FIG. 1.

FIG. 3 shows a perspective view illustrating an example of an elastic conductive member of the first embodiment.

FIG. 4 shows perspective views illustrating a connection structure of a first modification of the first embodiment.

FIG. 5 shows perspective views illustrating a connection structure of a second modification of the first embodiment.

FIG. 6 shows perspective views illustrating a connection structure of a third modification of the first embodiment.

FIG. 7 shows perspective views illustrating a connection structure of a fourth modification of the first embodiment.

FIG. 8 shows cross-sectional views illustrating an assembly according to a fifth modification of the first embodiment.

FIG. 9 shows cross-sectional views illustrating an assembly of a second embodiment.

FIG. 10 shows a perspective view illustrating an example of an elastic conductive member of the second embodiment.

FIG. 11 shows a cross-sectional view taken along line F11-F11 of the assembly illustrated in FIG. 9.

FIG. 12 shows a cross-sectional view illustrating an assembly according to a modification of the second embodiment.

### DETAILED DESCRIPTION OF THE INVENTION

Hereinafter, embodiments will be described with reference to the drawings. In the following description, constitutions having the same or similar functions are denoted by the same reference numbers. Redundant descriptions of these constitutions may be omitted. In the present disclosure, the terms are defined as follows. “Connection” is not limited to a mechanical connection, and may include an electrical connection. That is, “connection” is not limited to a case where two elements to be connected are directly connected, and may include a case where two elements to be connected are connected with another element interposed therebetween.

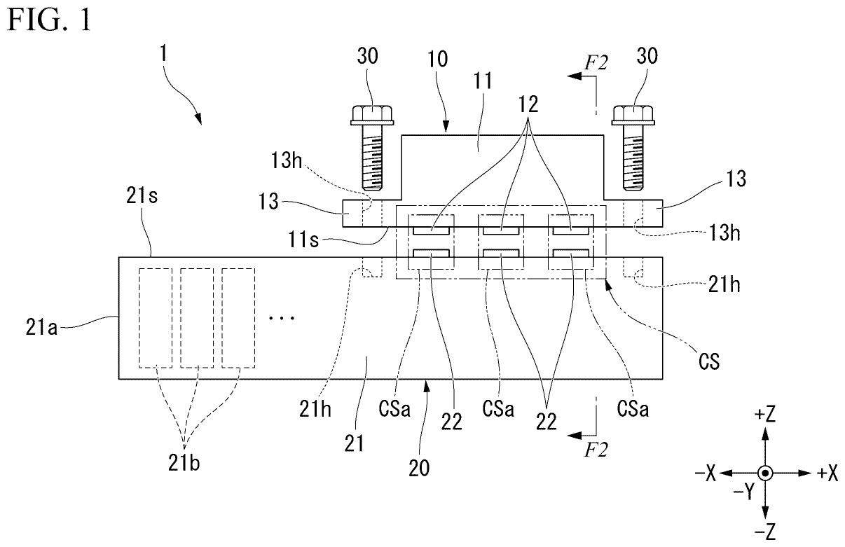

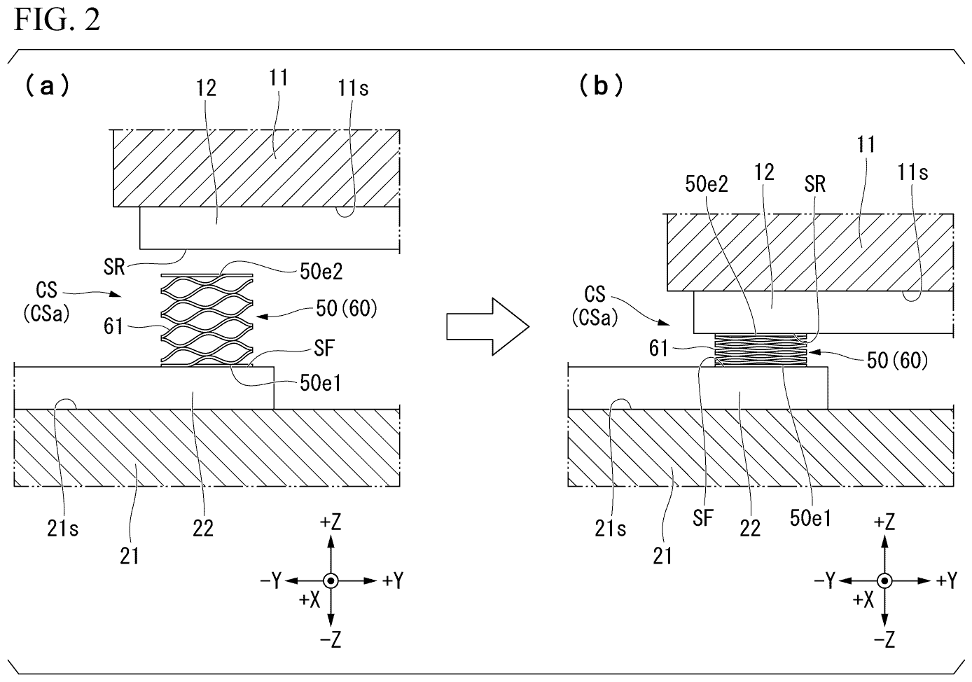

In the present disclosure, the −Z direction, the +Z direction, the −X direction, the +X direction, the −Y direction, and the +Y direction are defined as follows. The −Z direction is a direction from a device 11 to be described later toward a battery pack 21 to be described later (see FIG. 1). The +Z direction is a direction opposite to the −Z direction. When no distinction is made between the −Z direction and the +Z direction, the direction is simply referred to as “Z direction”. The −X direction and the +X direction are directions intersecting (e.g., orthogonal to) the Z direction. The −X direction is one direction in which a plurality of device bus bars 12 to be described later are arranged (see FIG. 1). The +X direction is a direction opposite to the −X direction. When no distinction is made between the −X direction and the +X direction, the direction is simply referred to as “X direction”. The −Y direction and the +Y direction are directions intersecting (e.g., orthogonal to) the Z direction and the X direction. The −Y direction is one direction in which the device bus bar 12 to be described later extends (see FIG. 2). The +Y direction is a direction opposite to the −Y direction. When no distinction is made between the −Y direction and the +Y direction, the direction is simply referred to as “Y direction”. In the embodiment described below, the −Z direction is an example of a “first direction”. Each of the X direction and the Y direction is an example of a “second direction”.

### FIRST EMBODIMENT

### A1. Constitution of Assembly

First, the constitution of an assembly 1 of a first embodiment will be described.

FIG. 1 shows a front view illustrating the assembly 1 of the first embodiment. Note that in FIG. 1, illustration of some components is omitted for convenience of description. The assembly 1 is a structure in which a plurality of modules (e.g., device 11 and battery pack 21) are integrated. The assembly 1 is mounted on a mobility unit such as an electric vehicle, for example. The assembly 1 includes, for example, a device unit 10, a battery unit 20, and a fixing member 30.

### A1.1 Device Unit

First, the device unit 10 will be described. The device unit 10 includes, for example, the device 11, a plurality of bus bars 12, and a flange 13. Hereinafter, for convenience of description, the bus bar 12 is referred to as a “device bus bar 12”.

### (Device)

The device 11 is a device having a function related to electric power. The device 11 is, for example, a device having one or more functions of power relay, distribution, cutoff (protection), conversion, charging, and the like. The device 11 is, for example, a high-voltage device such as a junction box, an on-board charger, or a DC-DC converter. Note, however, that the device 11 is not limited to the above example.

The device 11 has, for example, an installation surface 11s. The installation surface 11s is located at the −Z direction-side end of the device 11. The installation surface 11s is a surface facing the −Z direction. The installation surface 11s is, for example, a plane along the X direction and the Y direction. The installation surface 11s is formed of an insulating material.

### (Device Bus Bar)

The device bus bar 12 is a conductive member connected to the device 11. The device bus bar 12 is electrically connected to an electrode included in the device 11. In the present embodiment, a plurality of (e.g., three or more) device bus bars 12 are attached to the installation surface 11s of the device 11. The plurality of device bus bars 12 are arranged side by side in the X direction at intervals on the installation surface 11s. Each of the plurality of device bus bars 12 extends in the Y direction. The device bus bar 12 is formed of a conductive material such as metal. Note that details of the device bus bar 12 will be described later.

### (Flange)

The flange 13 is an overhanging portion provided in the device 11. The flange 13 is molded integrally with the device 11, for example. The pair of flanges 13 protrude from the device 11 to both sides in the X direction, for example. The flange 13 has a through hole 13h. The through hole 13h penetrates the flange 13 in the Z direction. The fixing member 30 to be described later is inserted into the through hole 13h from the +Z direction. Note that the flange 13 may be provided as a part of the device 11. If another fixing structure is provided, the flange 13 may be omitted.

### A1.2 Battery Unit

Next, the battery unit 20 will be described. The battery unit 20 includes, for example, the battery pack 21 and a plurality of bus bars 22. Hereinafter, for convenience of description, the bus bar 22 is referred to as a “battery bus bar 22”.

### (Battery Pack)

The battery pack 21 is a device including a plurality of battery cells 21b. The battery pack 21 includes, for example, a battery case 21a and the plurality of battery cells 21b. The battery case 21a is formed of an insulating material. The plurality of battery cells 21b are accommodated in the battery case 21a. The plurality of battery cells 21b are electrically connected in series, for example. The battery pack 21 has, for example, an installation surface 21s and an engagement hole 21h.

The installation surface 21s is located at the +Z direction-side end of the battery pack 21. The installation surface 21s is a surface facing the +Z direction. The installation surface 21s is, for example, a plane along the X direction and the Y direction. The installation surface 21s is formed of an insulating material.

The engagement hole 21h is provided at a position corresponding to the through hole 13h of the flange 13 of the device unit 10. The engagement hole 21h is opened on the installation surface 21s. The engagement hole 21h extends in the −Z direction from the installation surface 21s. The engagement hole 21h has a female screw. The fixing member 30 passed through the through hole 13h of the flange 13 of the device unit 10 is engaged with the engagement hole 21h.

### (Battery Bus Bar)

The battery bus bar 22 is a conductive member connected to the battery pack 21. The battery bus bars 22 are electrically connected to electrodes of the plurality of battery cells 21b included in the battery pack 21. In the present embodiment, a plurality of (e.g., three or more) battery bus bars 22 are attached to the installation surface 21s of the battery pack 21. The plurality of battery bus bars 22 are arranged side by side in the X direction at intervals on the installation surface 21s. Each of the plurality of battery bus bars 22 extends in the Y direction. The battery bus bar 22 is formed of a conductive material such as metal. Note that details of the battery bus bar 22 will be described later.

### A1.3 Fixing Member

The fixing member 30 is a member that fixes the device 11 and the battery pack 21. The fixing member 30 is, for example, a fastening member such as a bolt. In the present embodiment, the fixing member 30 is inserted into the through hole 13h of the flange 13 of the device unit 10 from the +Z direction, and is engaged with the engagement hole 21h of the battery pack 21. The fixing member 30 passed through the through hole 13h of the device unit 10 is engaged with the engagement hole 21h of the battery pack 21, whereby the device 11 and the battery pack 21 are fixed (fastened, for example). In the present embodiment, the fixing member 30 passed through the through hole 13h of the device unit 10 is engaged with the engagement hole 21h of the battery pack 21, whereby the device unit 10 and the battery unit 20 are fastened together. The device unit 10 and the battery unit 20 are integrated by thus being fastened together.

### A2. Connection Structure

Next, a connection structure CS provided in the assembly 1 will be described. The connection structure CS is a connection structure that electrically connects the device 11 and the battery pack 21. The connection structure CS is, for example, a structure that electrically connects a plurality of (e.g., three or more) device bus bars 12 and a plurality of (e.g., three or more) battery bus bars 22. In the present embodiment, the connection structure CS electrically connects the plurality of device bus bars 12 and the plurality of battery bus bars 22 in a one-to-one relationship. In the connection structure CS, for example, the plurality of device bus bars 12 and the plurality of battery bus bars 22 can be connected by a collective operation.

As illustrated in FIG. 1, in the present embodiment, the connection structure CS includes a plurality of connectors CSa electrically independent from each other. Each connector CSa is a connection structure that electrically connects one device bus bar 12 and one battery bus bar 22. The plurality of connectors CSa are arranged side by side in the X direction at intervals. In the present embodiment, the plurality of connectors CSa have the same constitution. Therefore, one connector CSa will be described below.

FIG. 2 shows cross-sectional views taken along line F2-F2 of the assembly 1 illustrated in FIG. 1. A section (a) of FIG. 2 illustrates a state before the assembly 1 is assembled (state before device 11 and battery pack 21 are fixed). A section (b) of FIG. 2 illustrates a state where the assembly 1 is assembled (state where device 11 and battery pack 21 are fixed by fixing member 30). The definitions of sections (a) and (b) in the drawings are the same in each drawing described below.

The connector CSa includes, for example, the device bus bar 12, the battery bus bar 22, and an elastic conductive member 50. Note that in the example described below, the elastic conductive member 50 is fixed to the battery bus bar 22 and provided as a part of the battery unit 20. Note, however, that instead of the above example, the elastic conductive member 50 may be fixed to the device bus bar 12 and provided as a part of the device unit 10. The content of this example will be described later as a modification.

### A2.1 Device Bus Bar

As described above, the device bus bar 12 is a conductive member connected to the device 11. In the present embodiment, the device bus bar 12 is an example of a “first conductor”.

The device bus bar 12 is, for example, a flat integrated metal plate. The device bus bar 12 extends, for example, along the installation surface 11s of the device 11. A surface of the device bus bar 12 has a receiving surface SR on which the elastic conductive member 50 abuts. The receiving surface SR is, for example, a plane along the X direction and the Y direction.

### A2.2 Battery Bus Bar

As described above, the battery bus bar 22 is a conductive member connected to the battery pack 21. The battery bus bar 22 overlaps at least a part of the device bus bar 12 when viewed in the Z direction. In the present embodiment, the battery bus bar 22 is an example of a “second conductor”.

The battery bus bar 22 is, for example, a flat integrated metal plate. The battery bus bar 22 extends, for example, along the installation surface 21s of the battery pack 21. A surface of the battery bus bar 22 has a fixing surface SF to which the elastic conductive member 50 is fixed. The fixing surface SF is, for example, a plane along the X direction and the Y direction.

### A2.3 Elastic Conductive Member

The elastic conductive member 50 is a member having conductivity and being elastically deformable. The elastic conductive member 50 is arranged between the device bus bar 12 and the battery bus bar 22 in the Z direction. When the device 11 and the battery pack 21 are fixed (fastened, for example) by the fixing member 30, the elastic conductive member 50 electrically connects the device bus bar 12 and the battery bus bar 22 while being elastically deformed and compressed between the device bus bar 12 and the battery bus bar 22. The elastic conductive member 50 is an example of an “elastic conductor”. Note that the “elastic conductor” in the present disclosure is not limited to a structure formed by one member (e.g., one elastic conductive member 50), and may be a structure formed by a plurality of members (e.g., a plurality of elastic conductive members 50).

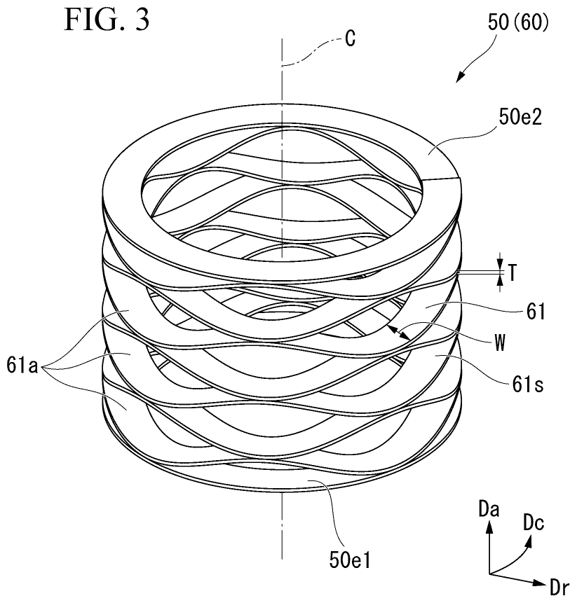

FIG. 3 shows a perspective view illustrating an example of the elastic conductive member 50. The elastic conductive member 50 is, for example, a metal spring member. In the present embodiment, the elastic conductive member 50 is a wave spring 60. The wave spring 60 includes a flat wire 61 curved (e.g., curved in wave shape) in the −Z direction or the +Z direction. In the present embodiment, the flat wire 61 has a plurality of curves 61a curved in the −Z direction or the +Z direction. The flat wire 61 is elastically deformable in the Z direction.

Here, an axial direction Da, a radial direction Dr, and a circumferential direction Dc of the wave spring 60 are defined. The axial direction Da is a direction along an axis C extending through the center of the wave spring 60 in the Z direction. The radial direction Dr is a direction radially separating from the axis C, which is the center of the wave spring 60. The circumferential direction Dc is a direction turning around the axis C while maintaining a certain distance from the axis C of the wave spring 60. A thickness T of the flat wire 61 in the axial direction Da is smaller than a width W of the flat wire 61 in the radial direction Dr. The flat wire 61 includes a plate surface 61s facing the Z direction.

In the present embodiment, the elastic conductive member 50 is a multilayer wave spring. In the multilayer wave spring, the above-described flat wire 61 is spirally wound over a plurality of layers. Note that the elastic conductive member 50 may be, for example, a single-layer wave spring. In the single-layer wave spring, the above-described flat wire 61 is formed in an annular shape within a range of one layer or less.

As illustrated in FIG. 2, the elastic conductive member 50 has a first end 50e1 and a second end 50e2. The first end 50e1 is fixed to the fixing surface SF of the battery bus bar 22. The first end 50e1 is fixed to the fixing surface SF of the battery bus bar 22 by being joined to the fixing surface SF of the battery bus bar 22 by, for example, welding or the like.

In the present embodiment, a portion of the flat wire 61 of the wave spring 60 included in the first end 50e1 does not have the curve 61a and has the plate surface 61s along the X direction and the Y direction (see FIG. 3). When the first end 50e1 does not have the curve 61a, a contact area (conduction area) between the elastic conductive member 50 and the battery bus bar 22 becomes larger. Note that the portion of the flat wire 61 of the wave spring 60 included in the first end 50e1 may have one or more (for example, a plurality of) curves 61a protruding toward the battery bus bar 22. Even when the first end 50e1 has the curve 61a, a contact area (conduction area) between the wave spring 60 and the battery bus bar 22 at the time of compression is larger than that in a case where a coil spring is used.

The second end 50e2 abuts on the receiving surface SR of the device bus bar 12. When the device 11 and the battery pack 21 are fixed, the second end 50e2 abuts on the receiving surface SR of the device bus bar 12 in a state where the elastic conductive member 50 is elastically deformed and compressed between the device bus bar 12 and the battery bus bar 22.

In the present embodiment, a portion of the flat wire 61 of the wave spring 60 included in the second end 50e2 does not have the curve 61a and has the plate surface 61s along the X direction and the Y direction (see FIG. 3). When the second end 50e2 does not have the curve 61a, a contact area (conduction area) between the elastic conductive member 50 and the device bus bar 12 becomes larger. Note that the portion of the flat wire 61 of the wave spring 60 included in the second end 50e2 may have one or more (for example, a plurality of) curves 61a protruding toward the device bus bar 12. Even when the second end 50e2 has the curve 61a, a contact area (conduction area) between the wave spring 60 and the device bus bar 12 at the time of compression is larger than that in a case where a coil spring is used.

### A3. Method of Manufacturing Assembly

Next, a method of manufacturing the assembly 1 will be described.

In the present embodiment, before the device unit 10 and the battery unit 20 are fixed, the elastic conductive member 50 is fixed to the battery bus bar 22 as a part of the battery unit 20. Next, the device unit 10 and the battery unit 20 are aligned such that the plurality of device bus bars 12 and the plurality of elastic conductive members 50 overlap each other when viewed in the Z direction. With this alignment, the elastic conductive member 50 is arranged between the device bus bar 12 and the battery bus bar 22.

Next, the device 11 and the battery pack 21 are fixed by the fixing member 30. At this time, the elastic conductive member 50 is sandwiched between the device bus bar 12 and the battery bus bar 22 as a gap between the device 11 and the battery pack 21 is narrowed through fastening by the fixing member 30, for example. Then, the elastic conductive member 50 is elastically deformed and compressed in the Z direction between the device bus bar 12 and the battery bus bar 22 as the fastening by, for example, the fixing member 30 progresses and the gap between the device 11 and the battery pack 21 becomes narrower. The elastic conductive member 50 electrically connects the device bus bar 12 and the battery bus bar 22 while being elastically deformed and compressed in the Z direction.

### A4. Operation

When the elastic conductive member 50 is compressed in the Z direction, the first end 50e1 of the elastic conductive member 50 is biased toward the battery bus bar 22. When the first end 50e1 of the elastic conductive member 50 is biased toward the battery bus bar 22, the contact pressure between the elastic conductive member 50 and the battery bus bar 22 is easily secured. Similarly, when the elastic conductive member 50 is compressed in the Z direction, the second end 50e2 of the elastic conductive member 50 is biased toward the device bus bar 12. When the second end 50e2 of the elastic conductive member 50 is biased toward the device bus bar 12, the contact pressure between the elastic conductive member 50 and the device bus bar 12 is easily secured.

In addition, when the elastic conductive member 50 which is the wave spring 60 is used, the elastic conductive member 50 is compressed in the Z direction, so that each curve 61a of the wave spring 60 is crushed in the Z direction while being in contact with another curve 61a adjacent in the Z direction. Such deformation increases the contact area (conduction area) between the curves 61a. When the contact area between the curves 61a increases, the conductivity of the elastic conductive member 50 in the Z direction increases.

### A5. Advantage

In the present embodiment, the connection structure CS includes the elastic conductive member 50. When the device 11 and the battery pack 21 are fixed, the elastic conductive member 50 electrically connects the device bus bar 12 and the battery bus bar 22 while being compressed between the device bus bar 12 and the battery bus bar 22. When the elastic conductive member 50 is compressed, the elastic conductive member 50 is biased toward at least one of the device bus bar 12 and the battery bus bar 22. When the elastic conductive member 50 is biased, it becomes easy to secure the contact pressure between the device bus bar 12 and the elastic conductive member 50 and/or between the battery bus bar 22 and the elastic conductive member 50. Therefore, stable electrical connection can be achieved between the device bus bar 12 and the battery bus bar 22.

In addition, in the structure in which the plurality of device bus bars 12 and the plurality of battery bus bars 22 are collectively connected, when the elastic conductive member 50 is compressively deformable, it is possible to reduce the force required for the operation of collective connection as compared with a case of using a rigid connector. Accordingly, workability can be improved.

In addition, in the structure in which the plurality of device bus bars 12 and the plurality of battery bus bars 22 are collectively connected, different tolerances exist depending on the individual device bus bars 12 or battery bus bars 22. However, when the elastic conductive member 50 is compressively deformable, it is possible to connect the plurality of device bus bars 12 and the plurality of battery bus bars 22 while absorbing the tolerance of each component. That is, when the elastic conductive member 50 is compressively deformable, it is easy to absorb the tolerance and secure an appropriate contact pressure in both the plurality of device bus bars 12 and the plurality of battery bus bars 22.

In the present embodiment, the elastic conductive member 50 has the second end 50e2 that abuts on a surface of the device bus bar 12. According to such a constitution, the elastic conductive member 50 can be directly connected to the device bus bar 12. When the elastic conductive member 50 can be directly connected to the device bus bar 12, the constitution of the connection structure CS can be simplified. When the constitution of the connection structure CS can be simplified, the size of the assembly 1 can be reduced.

In the present embodiment, the elastic conductive member 50 is a wave spring 60. When the elastic conductive member 50 is the wave spring 60, there are the following advantages as compared with a case where a normal coil spring is used. That is, when the wave spring 60 is compressed between the device bus bar 12 and the battery bus bar 22, the second end 50e2 of the wave spring 60 tends to be parallel to the device bus bar 12. When the second end 50e2 of the wave spring 60 tends to be parallel to the device bus bar 12, it is easy to secure the contact area between the wave spring 60 and the device bus bar 12. When the contact area (conduction area) between the wave spring 60 and the device bus bar 12 is easily secured, more stable electrical connection is easily achieved between the wave spring 60 and the device bus bar 12.

Similarly, when the wave spring 60 is compressed between the device bus bar 12 and the battery bus bar 22, the first end 50e1 of the wave spring 60 tends to be parallel to the battery bus bar 22. When the first end 50e1 of the wave spring 60 tends to be parallel to the battery bus bar 22, the contact area (conduction area) between the wave spring 60 and the battery bus bar 22 is easily secured. When the contact area between the wave spring 60 and the battery bus bar 22 is easily secured, more stable electrical connection is easily achieved between the wave spring 60 and the battery bus bar 22.

### A6. Modification

Next, some modifications of the first embodiment will be described. Note that the constitution other than that described below in each modification is the same as the constitution of the first embodiment described above.

### A6.1 First Modification

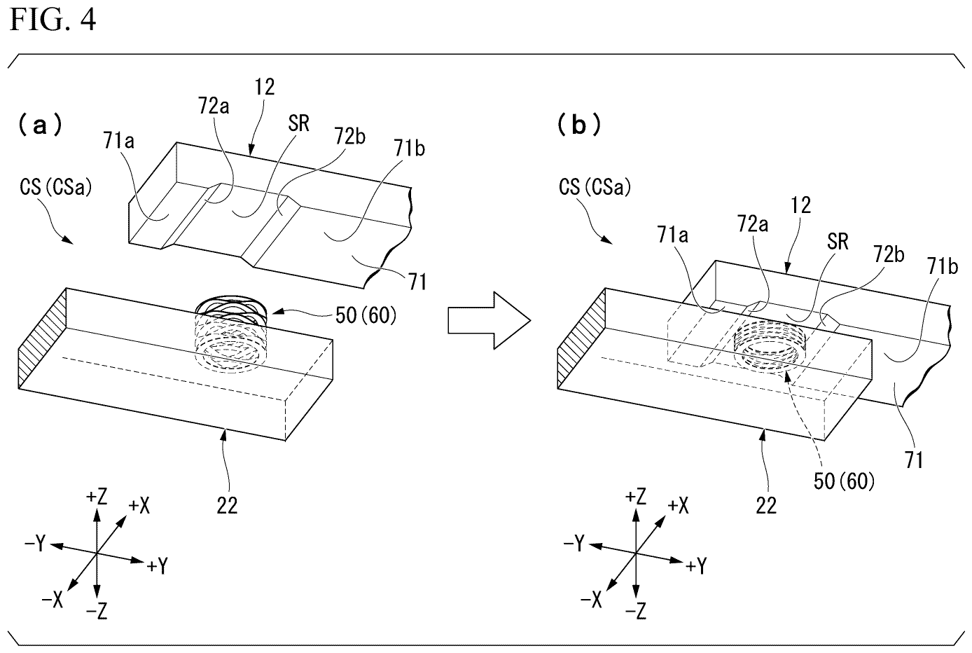

FIG. 4 shows perspective views illustrating a connection structure CS of a first modification. In the present modification, a device bus bar 12 includes an end surface 71, a receiving surface SR, a first inclined surface 72a, and a second inclined surface 72b.

The end surface 71 is a surface on the −Z direction side of the device bus bar 12. The end surface 71 includes a first portion 71a and a second portion 71b. The first portion 71a and the second portion 71b are arranged separately on both sides of the receiving surface SR in the Y direction. The receiving surface SR is arranged at a position recessed toward the +Z direction side with respect to the end surface 71.

The first inclined surface 72a is arranged between the first portion 71a of the end surface 71 and the receiving surface SR. The first inclined surface 72a connects the first portion 71a of the end surface 71 and the receiving surface SR. The first inclined surface 72a is inclined with respect to the end surface 71 so as to be positioned on the +Z direction side as it advances from the first portion 71a of the end surface 71 toward the receiving surface SR. The first inclined surface 72a faces the elastic conductive member 50 from the −Y direction. The first inclined surface 72a curbs tilting of an elastic conductive member 50 and restricts positional deviation of the elastic conductive member 50 in the Y direction. The first inclined surface 72a is an example of a “position restrictor”.

The second inclined surface 72b is arranged between the second portion 71b of the end surface 71 and the receiving surface SR. The second inclined surface 72b connects the second portion 71b of the end surface 71 and the receiving surface SR. The second inclined surface 72b is inclined with respect to the end surface 71 so as to be positioned on the +Z direction side as it advances from the second portion 71b of the end surface 71 toward the receiving surface SR. The second inclined surface 72b faces the elastic conductive member 50 from the +Y direction. The second inclined surface 72b curbs tilting of the elastic conductive member 50 and restricts positional deviation of the elastic conductive member 50 in the Y direction. The second inclined surface 72b is another example of the “position restrictor”.

When the device bus bar 12 has the first inclined surface 72a and the second inclined surface 72b, positional deviation of the elastic conductive member 50 in the Y direction is restricted. When the positional deviation of the elastic conductive member 50 is restricted, the electrical connection between the device 11 and the battery pack 21 is further stabilized. In addition, when the device bus bar 12 has the inclined surfaces 72a and 72b, the elastic conductive member 50 is guided by the first inclined surface 72a or the second inclined surface 72b and arranged at an appropriate position even when an error occurs in alignment between the device 11 and the battery pack 21 at the time of manufacturing. Also from this viewpoint, the electrical connection between the device 11 and the battery pack 21 is more stable. Further, workability of assembly can be improved.

### A6.2 Second Modification

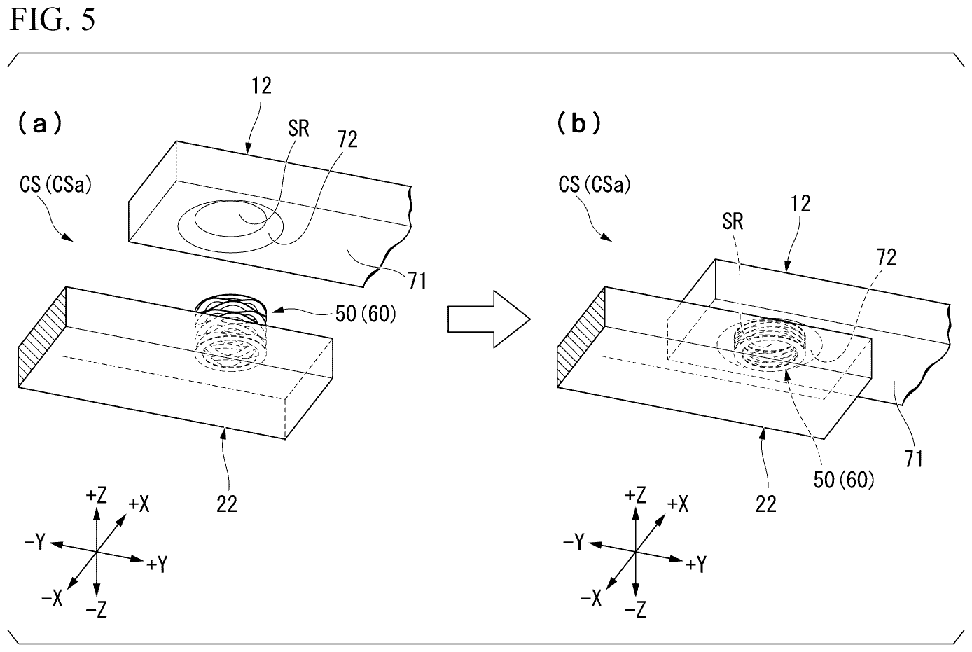

FIG. 5 shows perspective views illustrating a connection structure CS of a second modification. In the present modification, a device bus bar 12 includes an end surface 71, a receiving surface SR, and an inclined surface 72.

The end surface 71 is a surface on the −Z direction side of the device bus bar 12. The receiving surface SR is arranged at a position recessed toward the +Z direction side with respect to the end surface 71. The receiving surface SR is a circular shape having the same diameter as an elastic conductive member 50 or slightly larger than the elastic conductive member 50.

The inclined surface 72 is arranged between the end surface 71 and the receiving surface SR. The inclined surface 72 has an annular shape surrounding the receiving surface SR. The inclined surface 72 connects the end surface 71 and the receiving surface SR. The inclined surface 72 is inclined with respect to the end surface 71 so as to be positioned on the +Z direction side as it advances from the end surface 71 toward the receiving surface SR. The inclined surface 72 faces the elastic conductive member 50 from the X direction and the Y direction. The inclined surface 72 curbs tilting of the elastic conductive member 50 and restricts positional deviation of the elastic conductive member 50 in the X direction and the Y direction. The inclined surface 72 is an example of the “position restrictor”.

When the device bus bar 12 has the inclined surface 72, positional deviation of the elastic conductive member 50 in the X direction and the Y direction is restricted. When the positional deviation of the elastic conductive member 50 is restricted, the electrical connection between the device 11 and the battery pack 21 is further stabilized. In addition, when the device bus bar 12 has the inclined surface 72, the elastic conductive member 50 is guided by the inclined surface 72 and arranged at an appropriate position even when an error occurs in alignment between the device 11 and the battery pack 21 at the time of manufacturing an assembly 1. Also from this viewpoint, the electrical connection between the device 11 and the battery pack 21 is more stable. Further, workability of assembly can be improved.

### A6.3 Third Modification

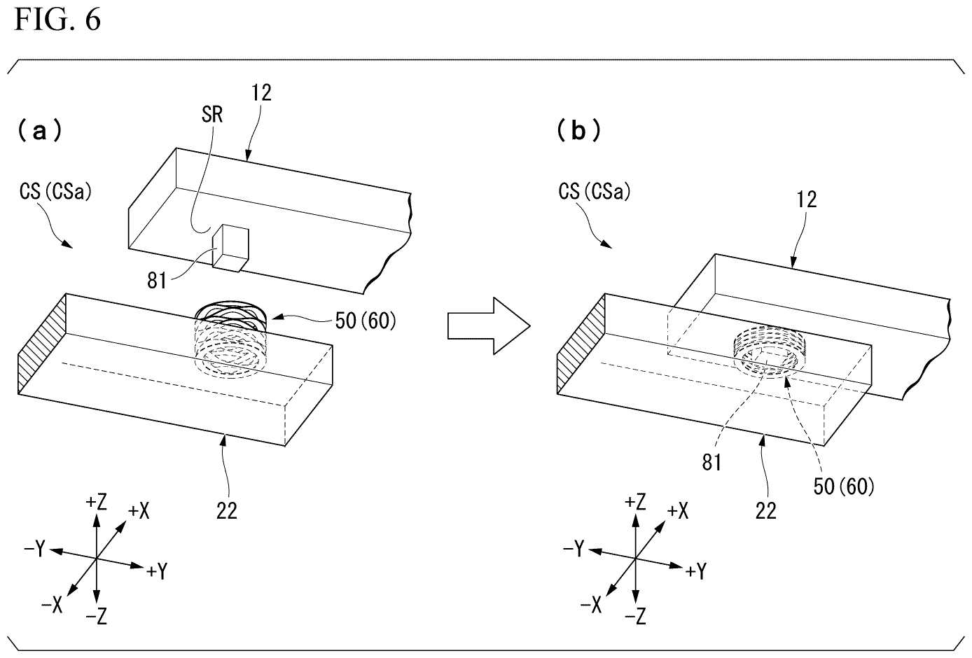

FIG. 6 shows perspective views illustrating a connection structure CS of a third modification. In the present modification, a device bus bar 12 includes a receiving surface SR and a protrusion 81. The protrusion 81 protrudes in the −Z direction from the central portion of the receiving surface SR. The protrusion 81 is inserted into a hollow elastic conductive member 50. The protrusion 81 faces the elastic conductive member 50 from the X direction and the Y direction. The protrusion 81 curbs tilting of the elastic conductive member 50 and restricts positional deviation of the elastic conductive member 50 in the X direction and the Y direction. The protrusion 81 is an example of the “position restrictor”. When the positional deviation of the elastic conductive member 50 is restricted by the protrusion 81, the electrical connection between a device 11 and a battery pack 21 is further stabilized.

### A6.4 Fourth Modification

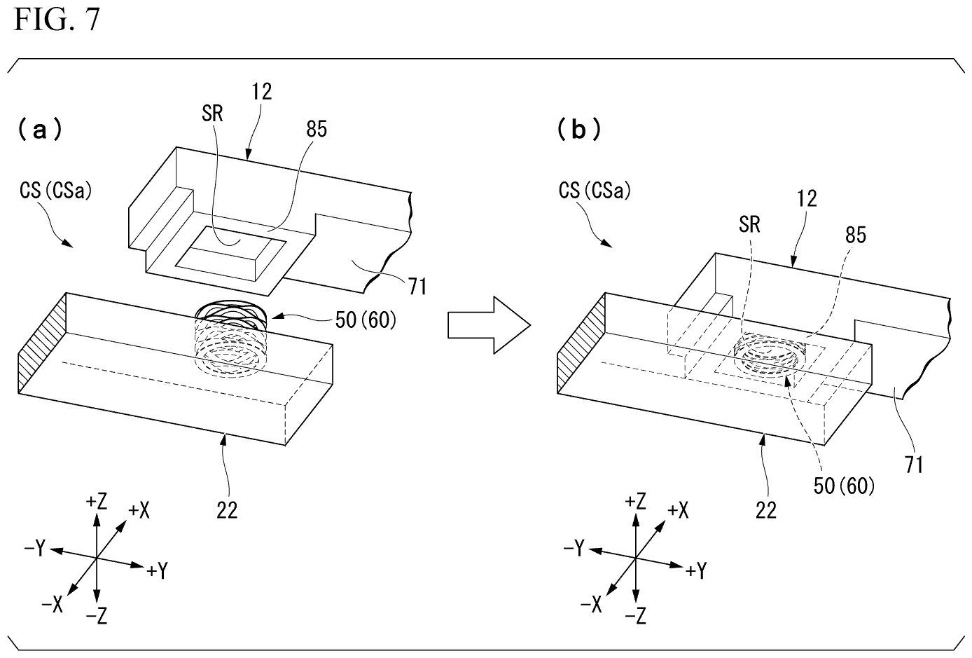

FIG. 7 shows perspective views illustrating a connection structure CS of a fourth modification. In the present modification, a device bus bar 12 includes a receiving surface SR and an annular protrusion 85. The annular protrusion 85 has a box shape or a cylindrical shape slightly larger than the diameter of an elastic conductive member 50. The annular protrusion 85 protrudes in the −Z direction from the periphery of the receiving surface SR. The annular protrusion 85 faces the outer periphery of the elastic conductive member 50. The annular protrusion 85 faces the elastic conductive member 50 from the X direction and the Y direction. The annular protrusion 85 curbs tilting of the elastic conductive member 50 and restricts positional deviation of the elastic conductive member 50 in the X direction and the Y direction. The annular protrusion 85 is an example of the “position restrictor”. When the positional deviation of the elastic conductive member 50 is restricted by the annular protrusion 85, the electrical connection between a device 11 and a battery pack 21 is further stabilized.

### A6.5 Fifth Modification

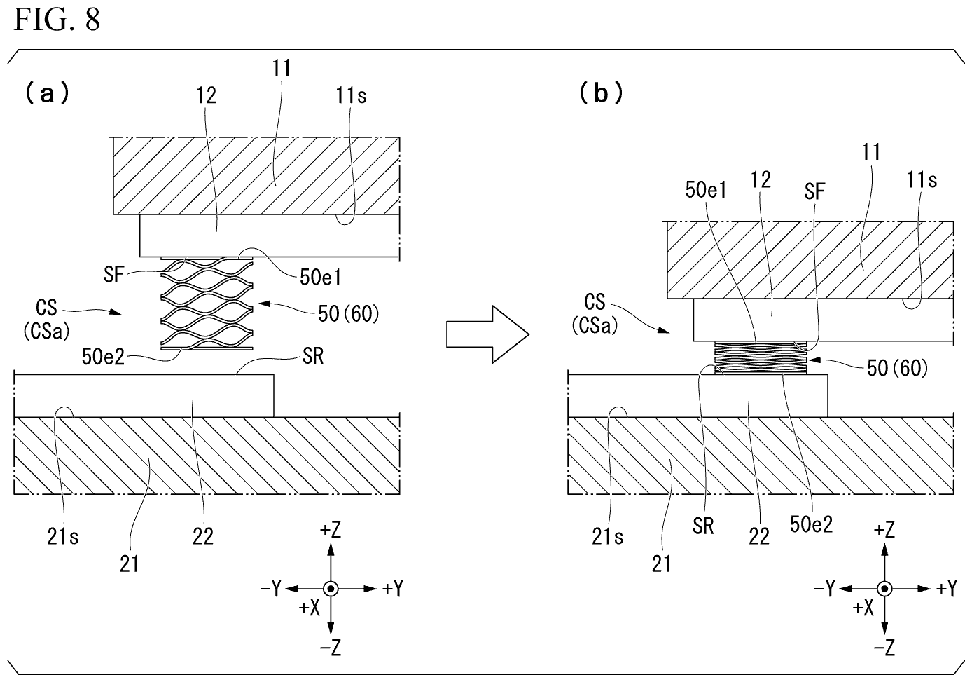

FIG. 8 shows cross-sectional views illustrating an assembly 1 of a fifth modification. In the present modification, an elastic conductive member 50 is provided as a part of a device unit 10 and is attached to a device bus bar 12. A first end 50e1 of the elastic conductive member 50 is fixed (for example, joined) to a fixing surface SF of the device bus bar 12. A second end 50e2 of the elastic conductive member 50 abuts on a receiving surface SR of a battery bus bar 22. Even in such a constitution, when the elastic conductive member 50 is biased, the contact pressure is easily secured. In the present modification, a battery bus bar 22 is an example of the “first conductor”. A device bus bar 12 is an example of the “second conductor”. Note that the constitution of the present modification may be applied in combination with the first to fourth modifications described above.

### Second Embodiment

Next, a second embodiment will be described. The second embodiment is different from the first embodiment in that an elastic conductive member 50 which is a canted coil spring 90 is provided. Note that the constitution other than that described below is the same as the constitution of the first embodiment described above.

### B1. Constitution of Assembly

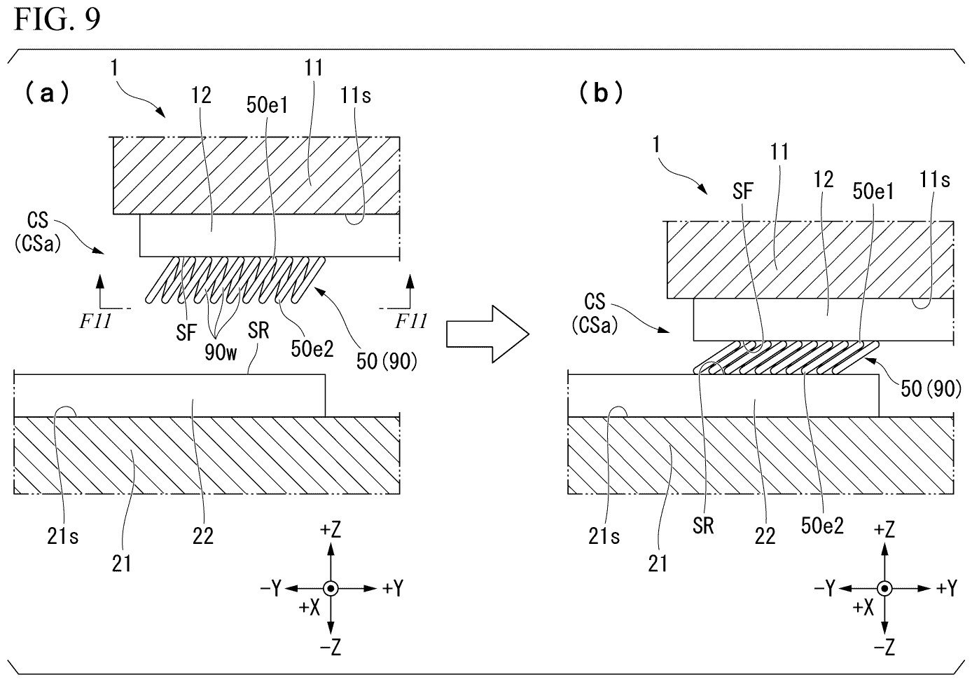

FIG. 9 shows cross-sectional views illustrating an assembly 1 of the second embodiment. In the present embodiment, each connector CSa includes a device bus bar 12, a battery bus bar 22, and the elastic conductive member 50.

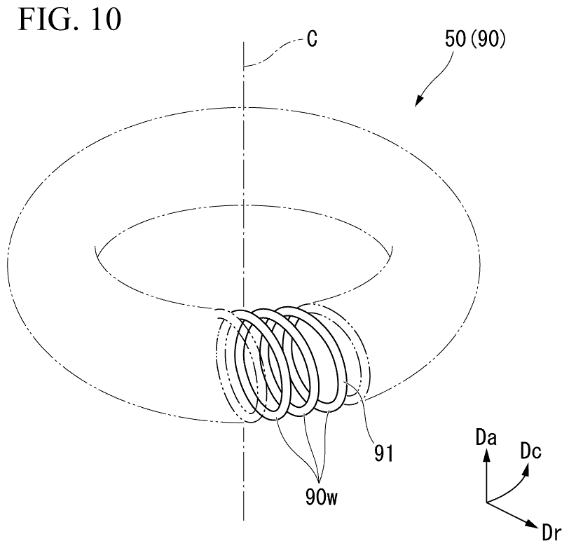

FIG. 10 shows a perspective view illustrating an example of the elastic conductive member 50 of the second embodiment. In the present embodiment, the elastic conductive member 50 is the canted coil spring 90. The canted coil spring 90 is a spring member formed by obliquely winding a wire 91. Each of the canted coil springs 90 has a plurality of windings 90w in which the wire 91 is obliquely wound.

Here, an axial direction Da, a radial direction Dr, and a circumferential direction Dc of the canted coil spring 90 are defined. The axial direction Da is a direction along an axis C extending in the Z direction through the center of the canted coil spring 90. The radial direction Dr is a direction radially separating from the axis C, which is the center of the canted coil spring 90. The circumferential direction Dc is a direction turning around the axis C while maintaining a certain distance from the axis C of the canted coil spring 90.

The wire 91 of the canted coil spring 90 extends spirally in the circumferential direction Dc while being inclined with respect to the circumferential direction Dc. The canted coil spring 90 collapses so that the inclination for each turn of the wire 91 increases when compressed in the axial direction Da. The canted coil spring 90 is compressed in the Z direction without changing the contact area (conduction area) with the device bus bar 12 and the battery bus bar 22 when elastically deformed and compressed between the device bus bar 12 and the battery bus bar 22.

FIG. 11 shows a cross-sectional view taken along line F11-F11 of the assembly 1 illustrated in FIG. 9. The outer diameter of the canted coil spring 90 is smaller than the width of the device bus bar 12 in the X direction, for example. In the present embodiment, the entire canted coil spring 90 faces the device bus bar 12. Similarly, the entire canted coil spring 90 faces the battery bus bar 22.

As illustrated in FIG. 9, the elastic conductive member 50 has a first end 50e1 and a second end 50e2. In the present embodiment, the first end 50e1 is fixed to a fixing surface SF of the device bus bar 12. The first end 50e1 is fixed to the fixing surface SF of the device bus bar 12 by being joined to the fixing surface SF of the device bus bar 12 by welding or the like, for example. In the present embodiment, a portion of each winding 90w included in the first end 50e1 is fixed to the fixing surface SF of the device bus bar 12.

On the other hand, the second end 50e2 abuts on a receiving surface SR of the battery bus bar 22. When a device 11 and a battery pack 21 are fixed, the second end 50e2 abuts on the receiving surface SR of the battery bus bar 22 in a state where the elastic conductive member 50 is elastically deformed and compressed between the device bus bar 12 and the battery bus bar 22. In the present embodiment, a portion of each winding 90w included in the second end 50e2 abuts on the receiving surface SR of the battery bus bar 22.

### B2. Method of Manufacturing Assembly

In the present embodiment, before a device unit 10 and a battery unit 20 are fixed, the elastic conductive member 50 is fixed to the device bus bar 12 as a part of the device unit 10. Next, the device unit 10 and the battery unit 20 are aligned so that the plurality of battery bus bars 22 and the plurality of elastic conductive members 50 overlap each other when viewed in the Z direction. Next, the device 11 and the battery pack 21 are fixed by the fixing member 30. At this time, the elastic conductive member 50 is sandwiched between the device bus bar 12 and the battery bus bar 22, and is elastically deformed and compressed between the device bus bar 12 and the battery bus bar 22.

### B3. Advantage

In the present embodiment, the elastic conductive member 50 is the canted coil spring 90. According to such a constitution, as compared with a case where the compression coil spring is used, it is easy to secure a large contact area (conduction area) between the elastic conductive member 50 and the device bus bar 12 and/or between the elastic conductive member 50 and the battery bus bar 22. In addition, when the elastic conductive member 50 is the canted coil spring 90, since the plurality of windings 90w in contact with the device bus bar 12 and the battery bus bar 22 are present, high conductivity between the device bus bar 12 and the battery bus bar 22 is easily secured.

Note that the elastic conductive member 50 which is the canted coil spring 90 may be fixed to the battery bus bar 22 instead of being fixed to the device bus bar 12. The same applies to a modification of the second embodiment described later.

### B4. Modification

Next, a modification of the second embodiment will be described. Note that the constitution other than that described below in the present modification is the same as the constitution of the second embodiment described above.

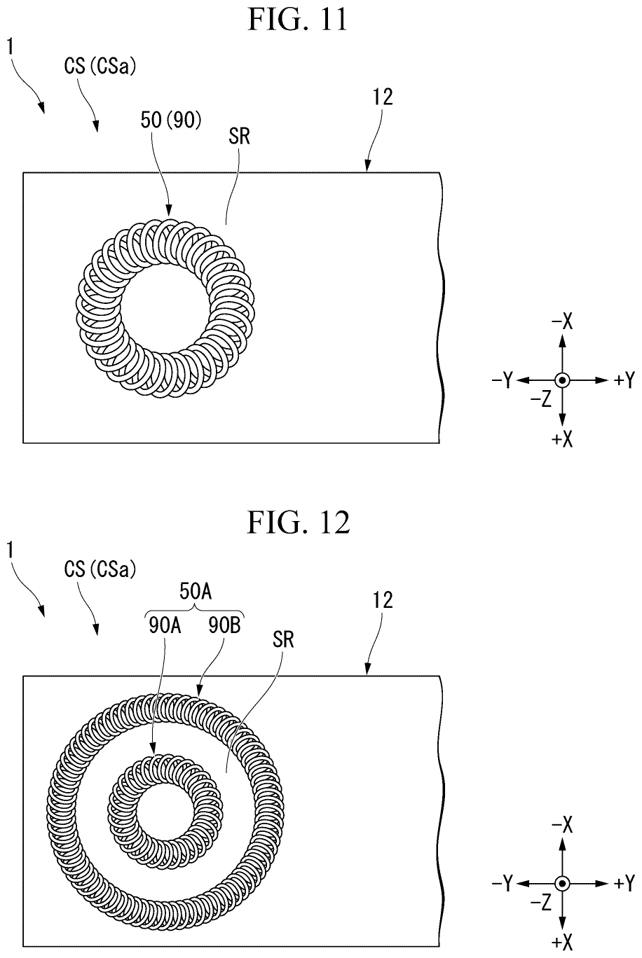

FIG. 12 shows a cross-sectional view illustrating an assembly 1 according to the modification of the second embodiment. In the present modification, each connector CSa includes an elastic conductor 50A instead of the elastic conductive member 50 of the second embodiment. When a device 11 and a battery pack 21 are fixed, the elastic conductor 50A electrically connects a device bus bar 12 and a battery bus bar 22 while being elastically deformed and compressed between the device bus bar 12 and the battery bus bar 22.

In the present modification, the elastic conductor 50A includes a first canted coil spring 90A and a second canted coil spring 90B. Each of the first canted coil spring 90A and the second canted coil spring 90B has a constitution similar to the canted coil spring 90 described above. The first canted coil spring 90A is formed in an annular shape. The second canted coil spring 90B is formed in an annular shape larger than the first canted coil spring 90A. The second canted coil spring 90B is arranged on the outer peripheral side of the first canted coil spring 90A.

In the present modification, two canted coil springs 90A and 90B are arranged. According to such a constitution, even when positional deviation in the X direction or the Y direction occurs between the device bus bar 12 and the battery bus bar 22, stable electrical connection can be easily secured by the two canted coil springs 90A and 90B.

Several embodiments and modifications have been described above. Note, however, that the embodiments and modifications are not limited to the examples described above. For example, the elastic conductive member 50 may be another type of spring member such as a coil winding spring or a disc spring.

The structure of the assembly 1 and the connection structure CS described above may be applied to a combination (a combination of any first module and any second module) other than the device 11 and the battery pack 21. The device 11 is an example of a “first module”. The battery pack 21 is an example of a “second module”. However, both the “first module” and the “second module” may be the same type of device. Alternatively, the “first module” and the “second module” may be different types of devices. Alternatively, both the “first module” and the “second module” may be a battery pack.

While preferred embodiments of the invention have been described and illustrated above, it should be understood that these are exemplary examples of the invention and are not to be considered as limiting. The embodiments described above can be implemented in various other forms, and various additions, omissions, substitutions, and other modifications can be made without departing from the scope of the present invention. Accordingly, the invention is not to be considered as being limited by the foregoing description, and is only limited by the scope of the appended claims.

### INDUSTRIAL APPLICABILITY

According to the present disclosure, it is easy to secure the contact pressure of a conductor.

### BRIEF DESCRIPTION OF THE REFERENCE SYMBOLS

1 Assembly
10 Device unit
11 Device
12 Device bus bar (first conductor, second conductor)
20 Battery unit
21 Battery pack
22 Battery bus bar (first conductor, second conductor)
30 Fixing member
50 Elastic conductive member (elastic conductor)
60 Wave spring
72, 72a, 72b Inclined surface (position restrictor)
81 Protrusion (position restrictor)
85 Annular protrusion (position restrictor)
90 Canted coil spring
90A First canted coil spring
90B Second canted coil spring
CS Connection structure
CSa Connector

What is claimed is:

1. A connection structure for electrically connecting a device and a battery pack, the connection structure comprising:
a first conductor connected to one of the device and the battery pack;
a second conductor that is connected to the other of the device and the battery pack and overlaps at least a part of the first conductor when viewed in a first direction from the device toward the battery pack; and
an elastic conductor that is arranged between the first conductor and the second conductor in the first direction and electrically connects the first conductor and the second conductor while being compressed between the first conductor and the second conductor when the device and the battery pack are fixed.

2. The connection structure according to claim 1, wherein
the first conductor is a bus bar, and
the elastic conductor is a spring member having an end abutting on a surface of the bus bar.

3. The connection structure according to claim 1, wherein
the elastic conductor is a wave spring.

4. The connection structure according to claim 1, wherein
the elastic conductor is fixed to the second conductor, and
the first conductor includes a position restrictor that faces the elastic conductor in a second direction intersecting the first direction and restricts a positional deviation of the elastic conductor in the second direction.

5. The connection structure according to claim 1, wherein
the elastic conductor is a canted coil spring.

6. The connection structure according to claim 1, wherein
the elastic conductor includes a first canted coil spring formed in an annular shape and a second canted coil spring formed in an annular shape larger than the first canted coil spring and arranged on an outer peripheral side of the first canted coil spring.

7. An assembly comprising:
a device;
a battery pack; and
a connection structure that electrically connects the device and the battery pack,
wherein the connection structure includes
a first conductor connected to one of the device and the battery pack,
a second conductor that is connected to the other of the device and the battery pack and overlaps at least a part of the first conductor when viewed in a first direction from the device toward the battery pack, and
an elastic conductor that is arranged between the first conductor and the second conductor in the first direction and electrically connects the first conductor and the second conductor while being compressed between the first conductor and the second conductor when the device and the battery pack are fixed.
